(19) United States
(12) Patent Application Publication
(10) Pub. No.: US 2005/0099124 A1
(43) Pub. Date: May 12, 2005

(54) Plasma display panel

(76) Inventors: Po-Cheng Chen, Yonghe City (TW); Jiun-Han Wu, Sanchong City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/891,576

(22) Filed: Jul. 15, 2004

(30) Foreign Application Priority Data
Nov. 11, 2003 (TW) 92131495

(51) Int. Cl. H01J 17/49

(52) U.S. Cl. 313/582

(57) ABSTRACT

A plasma display panel with uniform discharge characteristics. The plasma display panel comprises a buffer layer located between display regions and exhaust holes to force impurities produced during an exhausting process to accumulate between the buffer layer and sealing layer, and be successively adsorbed by a getter layer. As a result, unusual discharge characteristics and nonuniform definitions induced by impurities can be prevented.

### BACKGROUND OF THE INVENTION

1. Field of the Invention

The present invention relates to a plasma display panel, and more particularly to a plasma display panel with uniform discharge characteristics.

2. Description of the Related Art

Flat panel displays (FPD), such as liquid crystal displays (LCD), organic light emitting diodes (OLED) and plasma display panels (PDP), are rapidly replacing cathode ray tubes (CRT). Plasma display panels are self-emitting, highly luminous, provide wider viewing angle, and have a simpler fabrication process. Thus they are a popular choice for industry.

A PDP is a display device employing charges accumulated by electrode discharge. Due to a variety of advantages, such as large scale, high capacity and full-color capability, the PDP has become one of the most popular flat panel displays for various applications.

FIG. 1 is a cross section of a conventional plasma display panel. A conventional PDP 10 comprises a front glass substrate 12 and a rear substrate 14, parallel and opposite each other. The front glass substrate 12 has a plurality of parallel transverse electrodes 20, and a protective layer 26 is further formed covering these transverse electrodes 20.

The rear glass substrate 14 has a plurality of barrier ribs 28 arranged in parallel and spaced apart dividing the gap between the substrates 12 and 14 into a plurality of groups of discharge spaces 16. Each group of the discharge spaces 16 includes a red discharge space, a green discharge space, and a blue discharge space.

Additionally, the rear glass substrate 14 has a plurality of parallel longitudinal electrodes 22 positioned in parallel and between two adjacent barrier ribs 28 to serve as address electrodes, and a dielectric layer 24 is further formed to cover these lengthwise electrodes 22. Moreover, a fluorescent layer 29 is coated on the rear glass substrate 14 and the sidewalls of the barrier ribs 28 within the discharge space 16. Two adjacent barrier ribs 28, the transverse electrode 20, the longitudinal electrode 22, the discharge space 16, and the fluorescent layer 29 comprise a discharge cell 30.

FIG. 2 is a top view of the conventional PDP 10. All discharge cells 30 of the PDP 10 comprise a display region 32, and a sealing layer 40 is formed outside the display region 32 bonding the peripheries of the substrates 12 and 14. Furthermore, the PDP 10 comprises an exhaust vent 50 formed in the rear glass substrate 14 and an exhaust pipe 60 connected the exhaust vent 50, for exhausting gas from and introducing discharge gas, such as Ar or Xe, into the discharge spaces 16.

In the conventional PDP structure, impurities result from formation of each element of the discharge cell 30.

Accordingly, after assembly of the PDP 10, gases and impurities reexhausted from the discharge spaces 16 in the PDP 10. During the exhaust process, however, impurities introduced in the discharge cells 30 near the exhaust vent 50. The remaining impurities degrade a discharge characteristic of the discharge cells 30 near the exhaust vent 50, to inhibiting performance thereof, due to resulting nonuniform discharge characteristics and definitions.

Therefore, it is necessary to efficiently remove impurities remaining in the PDP for preventing degradation of characteristics of the PDP from degradation.

### SUMMARY OF THE INVENTION

Accordingly, an object of the present invention is to provide a plasma display panel having a buffer layer located between a display region and an exhaust vent to forcing impurities in the PDP to accumulate between the buffer layer and a sealing layer, and be successively absorbed by a getter layer. As a result, nonuniform discharge characteristics and definitions induced by impurities can be prevented.

To achieve the above objects, according to the present invention, a plasma display panel comprises parallel first and second substrates apart separated by a predetermined distance. A sealing layer is formed between the first and second substrate for bonding peripheral regions of the first and second substrates. A display region for emitting light is located in a center region of the first and second substrates. An exhaust vent is formed in the second substrate outside the display region. A buffer layer is formed on the second substrate between the exhaust vent and the display region, and a getter layer is formed on the first substrate outside the display region.

According to the present invention, the second substrate comprises a first region between the sealing layer and the buffer layer, and the getter layer can be partially or fully formed on a second region, corresponding to the first region, of the first substrate. Moreover, the getter layer can be formed on the first substrate adjacent to the second region.

The present invention also provides another plasma display panel, comprising parallel first and second substrates apart separated by a predetermined distance. A sealing layer is formed between the first and second substrate for bonding peripheral regions of the first and second substrates. A display region for emitting light is located in a center region of the first and second substrates. An exhaust vent is formed in the second substrate outside the display region.

A buffer layer is formed on the second substrate between the exhaust vent and the display region, wherein the second substrate comprises a first region between the sealing layer and the buffer layer, and the first substrate comprises a second region corresponding to the first region. An active protective layer is formed on the display region of the first substrate extending to the second region.

According to the present invention, the active protective layer can be formed on the display region of the first substrate extending in the second region. The plasma display panel can further comprise a getter layer formed partially or completely on the second region, wherein the getter layer can be adjacent to the active protective layer.

A detailed description is given in the following embodiments with reference to the accompanying drawings.

### BRIEF DESCRIPTION OF THE DRAWINGS

The present invention can be more fully understood by reading the subsequent detailed description in conjunction with the examples and references made to the accompanying drawings, wherein:

FIG. 1 is a cross section of a conventional PDP after a sealing process.

FIG. 2 is a perspective view of a conventional PDP after a sealing process.

FIG. 3 is a cross section of a conventional PDP after a gas exhausting-injecting process.

FIG. 4 is a perspective view of the PDP according to the present invention.

FIG. 5 is a cross section of the PDP according to the present invention illustrating the positions of the buffer layer and the getter layer.

FIGS. 6 to 10b are partial perspective views of the PDPs according to the present invention.

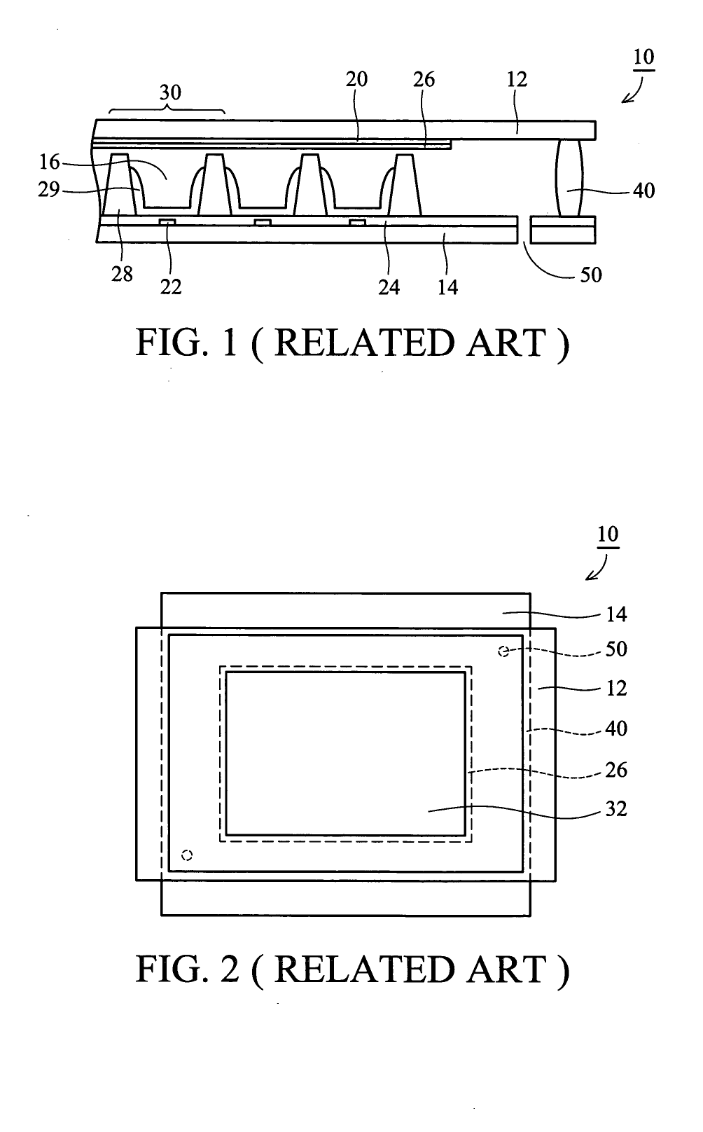

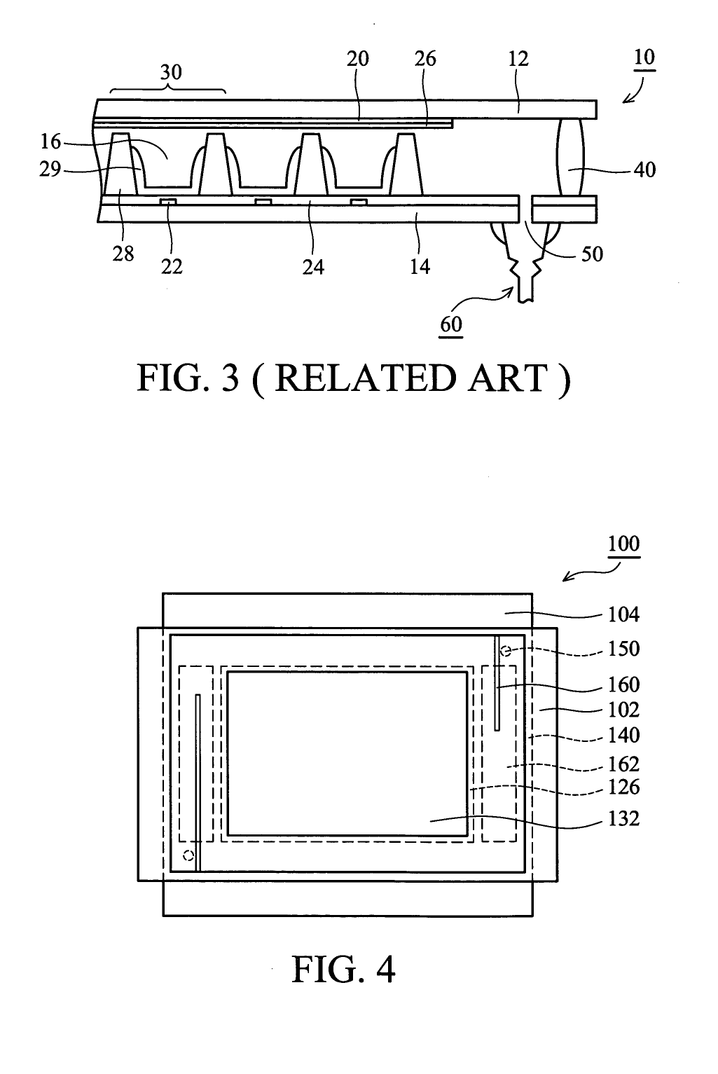

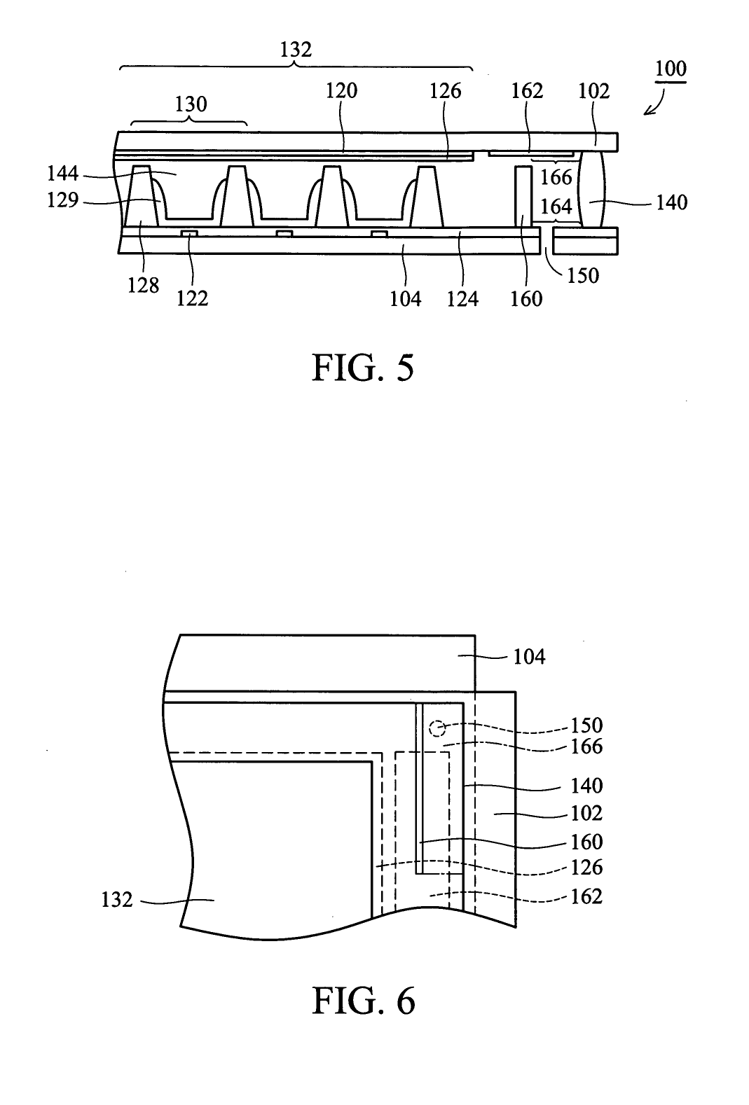

### DETAILED DESCRIPTION OF THE INVENTION

According to the present invention, the plasma display panel has a buffer layer located between a display region and an exhaust vent to forcing impurities in the PDP to accumulate between the buffer layer and a sealing layer, and successively absorbed by a getter layer. Therefore, the discharge characteristics of the PDP according to the present invention can be improved due to the increased purity of the discharge gas.

While a PDP is used to illustrate the invention, numerous modifications and variations will be apparent to those skilled in the art.

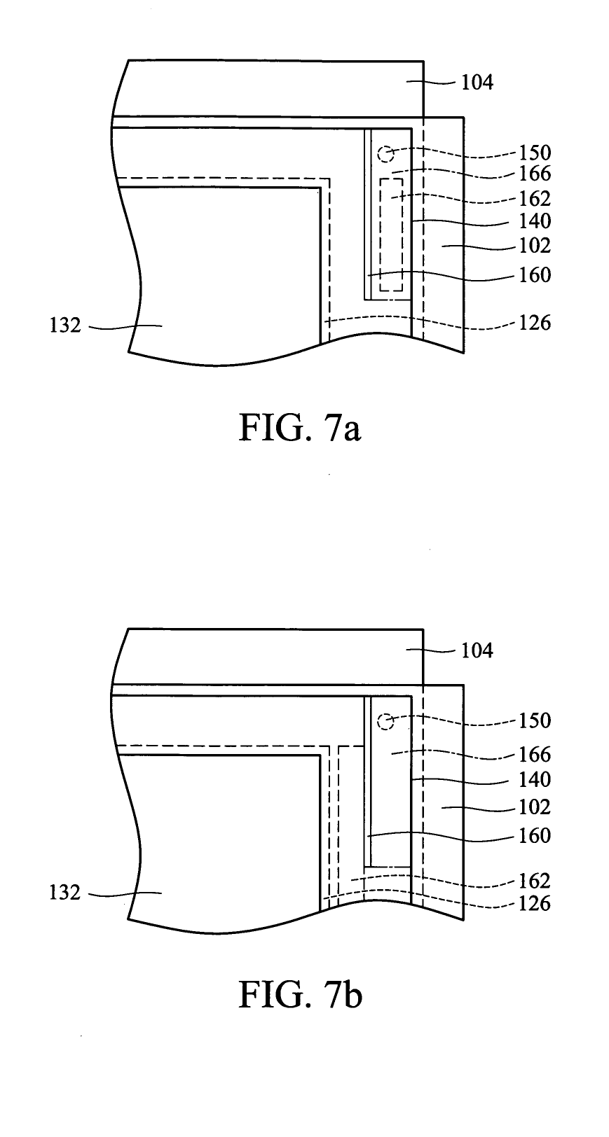

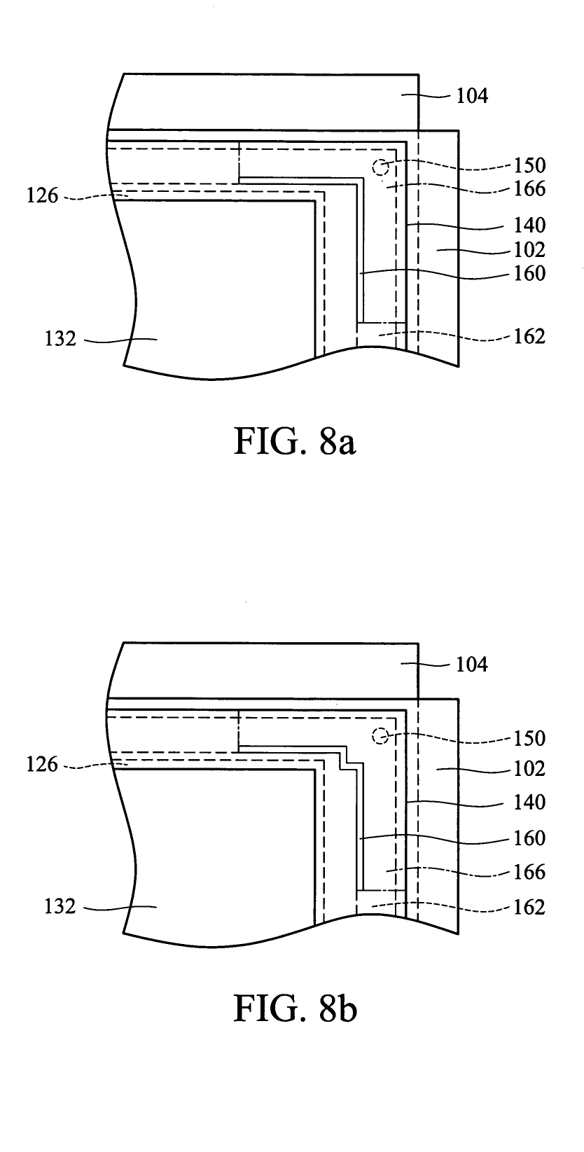

FIG. 4 is a perspective view of a PDP according to the present invention. The PDP 100 comprises a first substrate 102 and a second substrate 104 parallel to each other and separated by a predetermined distance. A display region 132 having a plurality of display cells is formed between the first substrate 102 and the second substrate 104. A sealing layer 140 is formed between the first substrate 102 and the second substrate 104 for bonding peripheral regions thereof respectively, and at least one exhaust vent 150 is formed penetrating the second substrate 104 outside the display region 132. Furthermore, referring to FIG. 5, the display cell 130 according to the present invention comprises a first electrode 120 formed on the first substrate 102, a protective layer 126 formed on the first electrode 120, a second electrode 122 formed on the second substrate 104 between two adjacent barrier ribs 128, a dielectric layer 124 formed over the second substrate 104 covering the second electrode 122, a phosphor layer 129 coated on the dielectric layer 124 and the barrier rib 128, and a discharge space 144.

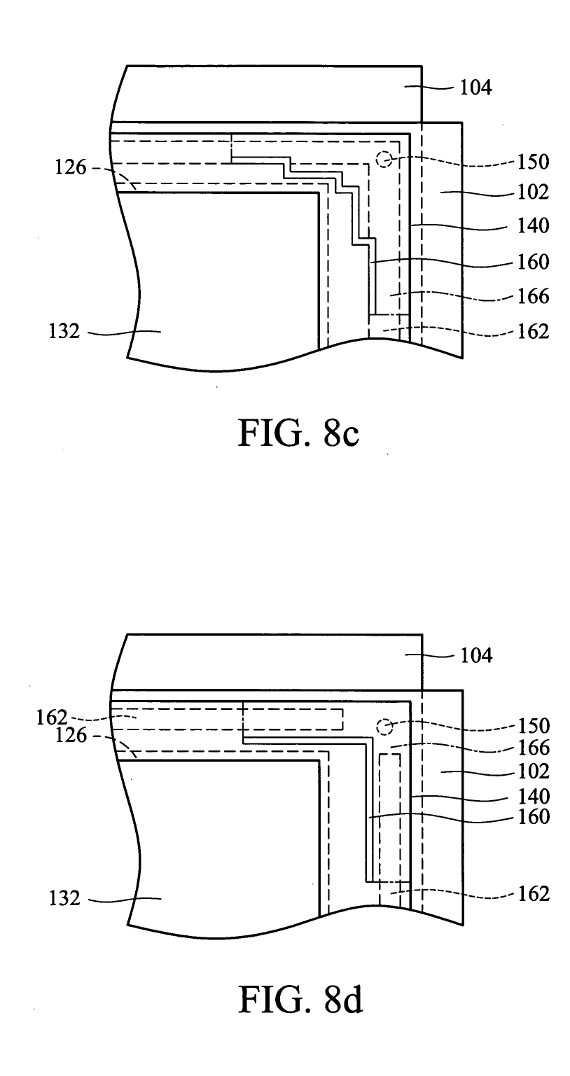

FIG. 6 is a partial perspective view of FIG. 4 further illustrating the PDP 100 according to the present invention. Specifically, the PDP 100 further comprises a buffer layer 160 formed on the second substrate 104 between the exhaust vent 150 and the display region 132, and a getter layer 162 formed on the first substrate 102 between the sealing layer 140 and the display region 132. The remaining impurities after exhausting gases from and injecting discharge-gases into the PDP 100 are forced to accumulate in the buffer layer 160. Suitable material for the buffer layer 160 can be the same as the sealing layer 140, such as an adhesive or a glass frit. Moreover, the getter layer 162 absorbs impurities accumulated in the buffer layer 160. Suitable material for the getter layer 162 can be a compound comprising magnesium, aluminum, or zirconium. Preferably, the getter layer and the protective layer 126 are the same material, such as magnesium oxide (MgO).

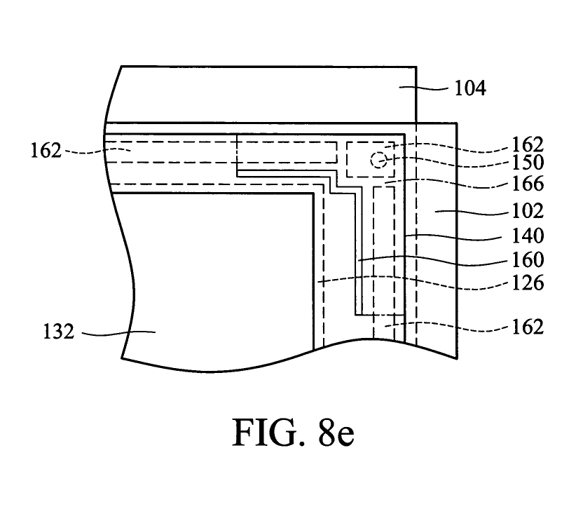

As shown in FIGS. 5 and 6, the second substrate 104 comprises a first region 164 between the buffer layer 160 and the sealing layer 140. Additionally, the first substrate 102 comprises a second region 166 corresponding to the first region 164. In the present invention, the getter layer 162 can be formed partially in the second region 166 as shown in FIG. 6. In another aspect, the getter layer 162 can be formed entirely in the second region 166 as shown in FIG. 7a. In yet another aspect, the getter layer 162 can be formed adjacent to the second region 166 as shown in FIG. 7b.

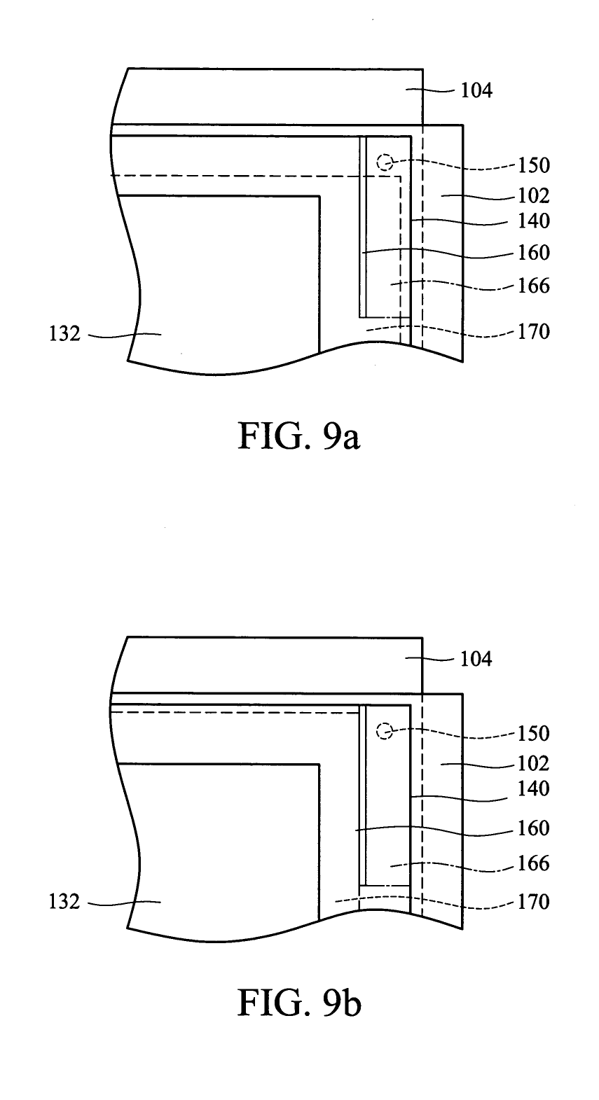

According to the present invention, the buffer layer 160 can be bar-shaped as shown in FIGS. 7a and 7b, or other shapes. For example, as shown in FIGS. 8a to 8e, the buffer layer 160 can be L-shaped or ladder-shaped. The getter layer 162 can be divided into several regions with the same or different dimensions as shown in FIGS. 8d and 8e. Moreover, the getter layer 162 can be cover a region, corresponding to the exhaust vent 150, of the first substrate 102.

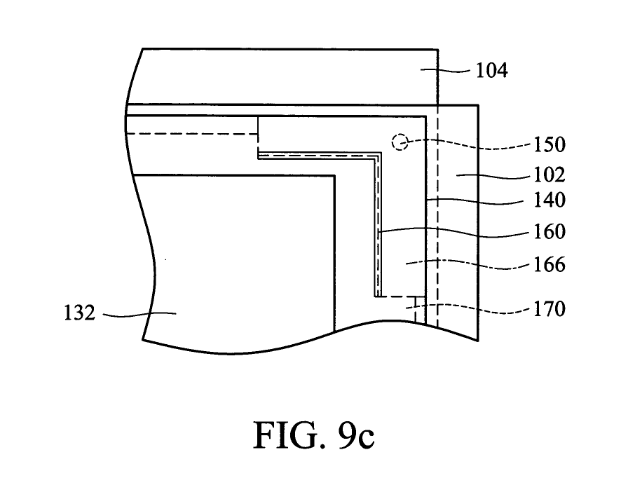

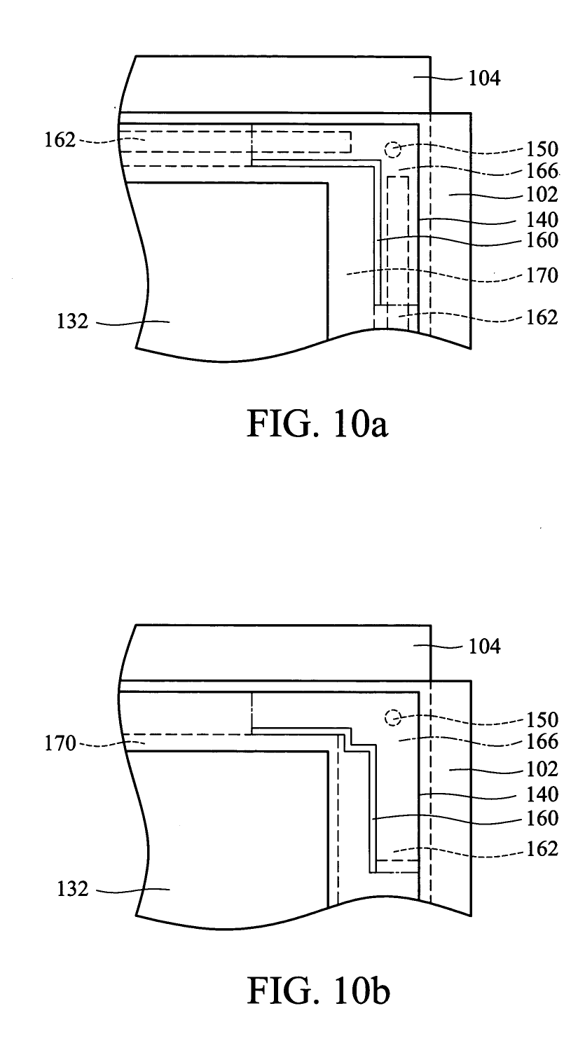

In the present invention, since the getter layer 162 and the protective layer 126 can be the same material, such as MgO, an active protective layer 132 can be deposited on the first substrate 102, substituting for the getter layer 162 and the protective layer 126 in one step, as shown in FIGS. 9a to 9c. Specifically, the active protective layer 132 is formed on the original position of the protective layer 126 and extends to the second region 166. In the present invention, the active protective layer 132 can cover the second region 166 as shown in FIGS. 9a and 9c. Moreover, the active protective layer 132 can be adjacent to the second region 166 as shown in FIG. 9b. Referring to FIGS. 10a and 10b, the PDP 100 comprising the active protective layer 132 can further comprise a getter layer, 162 formed partially or completely on the second region 166.

Accordingly, the PDP of the present invention comprising a buffer layer and a getter layer can effectively remove impurities from discharge spaces, such that, compared with conventional PDPs, unusual discharge characteristics and nonuniform definitions induced by impurities can be prevented. In addition, since the getter layer can be the same material as the protective layer and formed in the same step, the performance of the PDP according to the present invention can be improved without increasing process complexity or cost.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A plasma display panel, comprising:
a first substrate;
a second substrate parallel with the first substrate separated by a predetermined distance;
a sealing layer formed located between the first and second substrates for bonding a peripheral region of the first and second substrates;
a display region for emitting light located in a center region of the first and second substrates;
an exhaust vent formed in the second substrate outside the display region;
a buffer layer formed on the second substrate between the exhaust vent and the display region; and
a getter layer formed on the first substrate outside the display region.

2. The plasma display panel as claimed in claim 1, wherein the second substrate comprises a first region between the sealing layer and the buffer completely on a second region, corresponding to the first region, of the first substrate.

3. The plasma display panel as claimed in claim 1, wherein the second substrate comprises a first region between the sealing layer and the buffer layer, and the getter layer is formed adjacent to a second region, corresponding to the first region, of the first substrate.

4. The plasma display panel as claimed in claim 1, wherein the getter layer comprises a compound containing magnesium, aluminum, or zirconium.

5. The plasma display panel as claimed in claim 1, wherein the getter layer comprises magnesium oxide.

6. The plasma display panel as claimed in claim 1, further comprising a protective layer formed on the first substrate of the display region, wherein the protective layer and the getter layer comprise the same material.

7. The plasma display panel as claimed in claim 1, wherein the buffer layer is bar-shaped, L-shaped, or ladder-shaped.

8. The plasma display panel as claimed in claim 1, wherein the material of the buffer layer is an adhesive.

9. The plasma display panel as claimed in claim 1, wherein the material of the buffer layer is a glass frit.

10. A plasma display panel, comprising:
a first substrate;
a second substrate in parallel with the first substrate separated by a predetermined distance;
a sealing layer formed located between the first and second substrate for sealing a peripheral region of the first and second substrate;
a display region for emitting light located in a center region of the first and second substrate;
an exhaust vent formed in the second substrate outside the display region;
a buffer layer formed on the second substrate between the exhaust vent and the display region, and a first region between the buffer layer and the sealing layer of the second substrate; and
an active protective layer formed on the display region of the first substrate extending to a second region, corresponding to the first region, of the first substrate.

11. The plasma display panel as claimed in claim 10, wherein the active protective layer comprises magnesium oxide.

12. The plasma display panel as claimed in claim 10, wherein the buffer layer is bar-shaped, L-shaped, or ladder-shaped.

13. The plasma display panel as claimed in claim 10, wherein the material of the buffer layer is an adhesive.

14. The plasma display panel as claimed in claim 10, wherein the material of the buffer layer is a glass frit.

15. The plasma display panel as claimed in claim 10, wherein the buffer layer and the sealing layer comprise the same material.

16. The plasma display panel as claimed in claim 10, further comprising a getter layer formed on the second region.

17. The plasma display panel as claimed in claim 16, wherein the active protective layer is adjacent to the getter layer.

18. The plasma display panel as claimed in claim 16, wherein the getter layer comprises a compound containing magnesium, aluminum, or zirconium.

19. The plasma display panel as claimed in claim 16, wherein the getter layer comprises magnesium oxide.

20. The plasma display panel as claimed in claim 16, wherein the getter layer and the active protective layer are the same material.
